(19) United States
(12) Patent Application Publication
(10) Pub. No.: US 2019/0288548 A1
(43) Pub. Date: Sep. 19, 2019

(54) CHARGING SYSTEM OF BRUSHLESS MOTOR CONTINUOUS GENERATOR

(71) Applicant: FU-TE LAI, Tainan City (TW)

(72) Inventor: FU-TE LAI, Tainan City (TW)

(21) Appl. No.: 16/177,976

(22) Filed: Nov. 1, 2018

(30) Foreign Application Priority Data
Mar. 15, 2018 (TW) 107203363

(51) Int. Cl. H02J 7/14; H02P 6/14

(52) U.S. Cl. CPC H02J 7/1423; H02M 5/4585; H02P 6/14

(57) ABSTRACT

A charging system of a brushless motor continuous generator includes a brushless direct-current (BLDC) motor, a generator and an accumulation battery. The BLDC motor is connected to a motor controller, which adjusts a duty cycle through pulse width modulation (PWM) to change a rotational speed of the BLDC motor. The generator is connected to the BLDC motor. When the BLDC motor rotates, the generator is synchronously driven to generate power. The accumulation battery is electrically connected to the generator, stores electric energy, and provides the electric energy to the generator. The accumulation battery is further electrically connected to the motor controller of the BLDC motor, so as to provide the electric energy to operate the BLDC motor through the motor controller.

### FIELD OF THE INVENTION

The present invention relates to a brushless motor continuous generator, and more particularly, to a charging system of a brushless motor continuous generator, wherein the charging system is able to be continuously and stably generated power and achieving stable and uninterrupted power supply.

### BACKGROUND OF THE INVENTION

Various types of energy power sources are essential criteria in economic development. Energy sources are required by various common mechanical operations and households are usually electric power, which primarily originates from nuclear power generation and thermal power generation. Nuclear power generation involves safety concerns and nuclear pollution issues; thermal power generation is mainly generated from heat energy produced from burning carbohydrate fuel materials, that is, fuel, coal or natural gases. However, the acquisition of energy obtained from burning these carbohydrate fuel materials emits large amounts of carbon dioxide and other polluting gases, which cause global warming and air pollution and are extremely detrimental to sustainable development of the human race.

Carbon dioxide is universally recognized as the top perpetrator accountable for global warming, and the use of any carbon-containing fossil fuel emits carbon dioxide. To reduce carbon dioxide emission, there are currently two substantial approaches. The first approach is energy saving; that is, the amount of fossil fuel used is controlled to reduce carbon dioxide emission. The second approach is developing and using new energy; that is, new energy is used in replacement of fossil fuel to achieve the goal of carbon dioxide emission reduction or even zero carbon dioxide emission. Moreover, as the economic system adopting fossil fuel has permanently damaged Mother Earth on which lives of the human race depend and fossil fuel is also about to be depleted soon, the development of “new energy” is imminent.

Common new energy includes solar power and wind power at the current stage. However, operation and utilization of solar power generation and wind power generation are faced with various limitations, such as the intensity of sunshine and the strength of wind, resulting in instability and significant inconvenience in application as well as power generation.

### SUMMARY OF THE INVENTION

In view of the drawbacks of the prior art, it is a primary object of the present invention to provide a charging system of a brushless motor continuous power generator. The charging system is able to be continuously and stably generated power to achieve not only stable and uninterrupted power supply but also utilization convenience, providing enhanced practicability in overall implementation thereof.

According to the above object, the present invention provides a charging system of a brushless motor continuous generator, the charging system including a brushless direct-current (BLDC) motor, a generator and an accumulation battery. The BLDC motor is connected to a motor controller, and the motor controller adjusts a duty cycle through pulse width modulation (PWM) to change a rotational speed of the BLDC motor. The generator is connected to the BLDC motor. When the BLDC motor rotates, the generator is synchronously driven to generate power. The accumulation battery is electrically connected to the generator for storing electric energy, and the accumulation battery provides the electric energy to the generator. The accumulation battery is further electrically connected to the motor controller of the BLDC motor such that the electric energy is provided for operating the BLDC motor through the motor controller.

In another preferred embodiment, a charging system of a brushless motor continuous generator of the present invention, the BLDC motor is further connected to a magnetic generator, and the magnetic generator is electrically connected to the accumulation battery. When the BLDC motor rotates, the magnetic generator is synchronously driven to generate power, the magnetic generator generates electric energy, and the electric energy is transmitted to the accumulation battery and stored therein.

According to the above object, the present invention further provides another charging system of a brushless motor continuous generator, the charging system including a brushless DC (BLDC) motor, a generator, a magnetic generator and two accumulation batteries. The BLDC motor is connected to a motor controller, and the motor controller adjusts a duty cycle through pulse width modulation (PWM) to change a rotational speed of the BLDC motor. The generator is connected to the BLDC motor. When the BLDC motor rotates, the generator is synchronously driven to generate power. The magnetic generator is connected to the BLDC motor. When the BLDC motor rotates, the magnetic generator is synchronously driven to generate power. The generator and the magnetic generator are respectively electrically connected to the two accumulation batteries. The two accumulation batteries respectively store electric energy generated by the generator and the magnetic generator. One of the accumulation batteries is respectively connected to the magnetic generator and the motor controller of the BLDC motor, and provides electric energy for operating the BLDC motor through the motor controller. Another one of the accumulation batteries is electrically connected to the generator, and is used for an operation of a household appliance according to requirements.

### BRIEF DESCRIPTION OF THE DRAWINGS

FIG. 1 is a block diagram of a charging system of a brushless motor continuous generator of one embodiment according to the present invention;

FIG. 2 is a block diagram of a charging system of a brushless motor continuous generator of another embodiment according to the present invention;

FIG. 3 is a waveform diagram of conventional pulse width modulation (PWM) chopping control of the prior art;

FIG. 4 is a waveform diagram of an upper-bridge PWM chopping control according to the present invention;

FIG. 5 is a waveform diagram of a hybrid PWM chopping control according to the present invention;

FIG. 6 is a block diagram of a charging system of a brushless motor continuous generator of another embodiment according to the present invention; and

FIG. 7 is a circuit diagram of a charging system of a brushless motor continuous generator of another embodiment according to the present invention.

### DETAILED DESCRIPTION OF THE PREFERRED EMBODIMENTS

To completely and clearly exercise technical contents, invention objects and expected results of the present invention, detailed description is given with the accompanying drawings below.

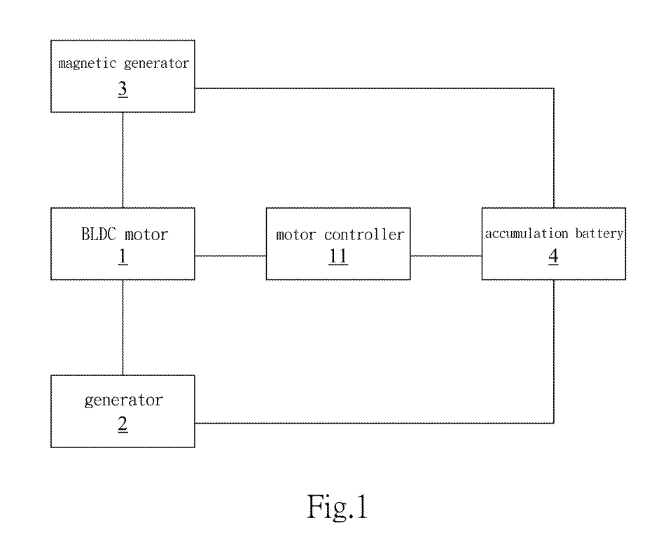

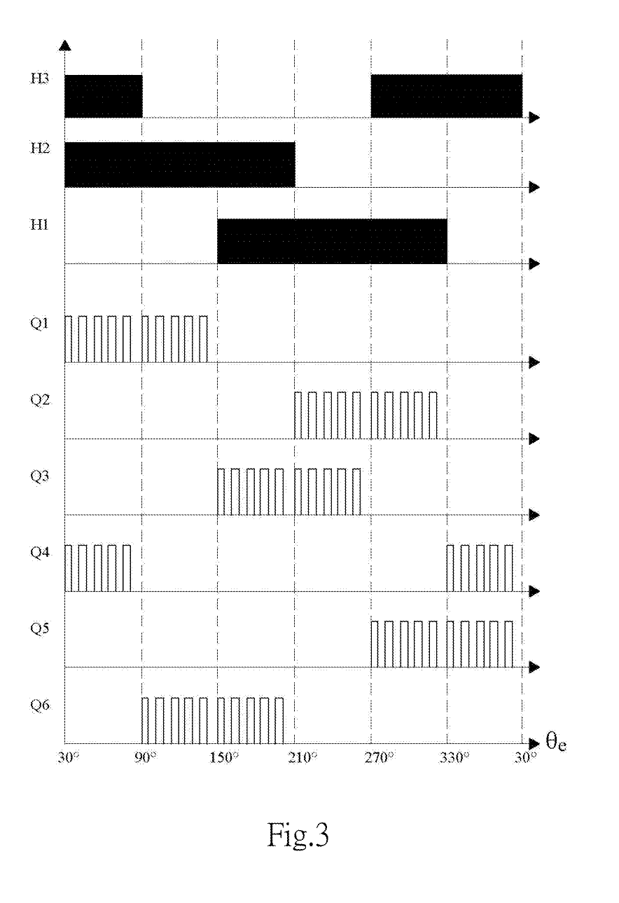

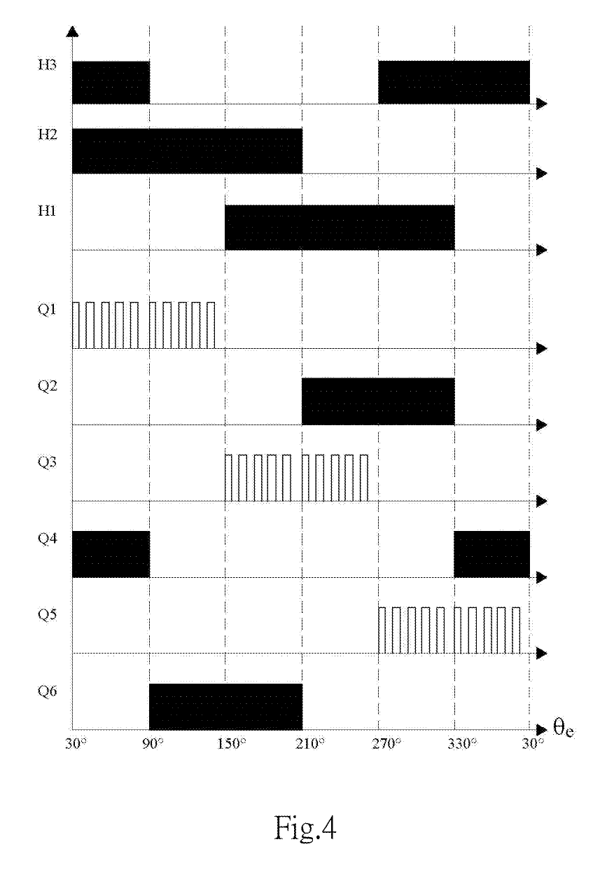

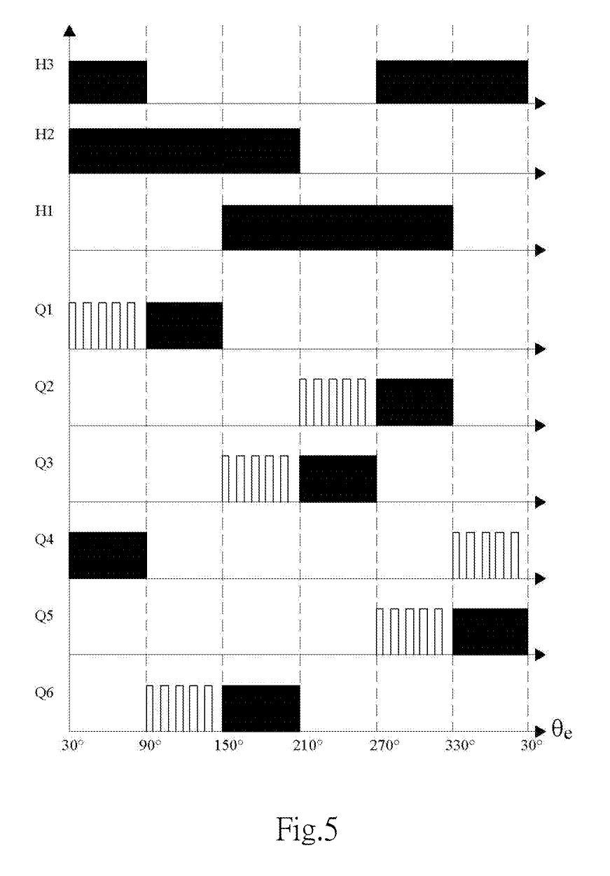

Refer to FIG. 1 as well as FIG. 3, FIG. 4 and FIG. 5. FIG. 1 shows a block diagram of a charging system of a brushless motor continuous generator according to one embodiment. FIG. 3 shows a waveform diagram of conventional pulse width modulation (PWM) chopping control. FIG. 4 shows a waveform diagram of upper-bridge-type PWM chopping control. FIG. 5 is a waveform diagram of hybrid PWM chopping control (PWM-ON, ON-PWM, and PWM-ON-PWM) according to the technology provided by the present invention. The charging system of a brushless motor continuous generator is applicable to power plants, industrial electricity and household electricity. It should be noted that the above purposes are examples and are not to be construed as limitations to the application scope of the present invention.

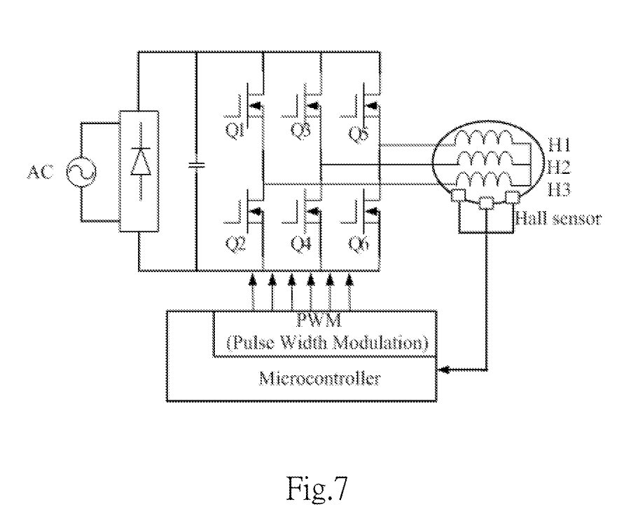

The charging system of a brushless motor continuous generator includes a brushless DC (BLDC) motor 1, a generator 2, a magnetic generator 3 and an accumulation battery 4 shown as FIG. 1. The BLDC motor 1 is connected to a motor controller 11, which is conducted by three-phase electric power. In the three-phase, each phase is offset from the other by 120°. That is, among three phases of winding, only two phases of winding are used to drive the BLDC motor 1. Thus, in each interval of the three phases of winding, only two power transistors (not shown) and two flywheel diodes (not shown) are used; further, a stator winding current is directionally proportional to a motor torque. The BLDC motor 1 comprises a stator winding (not shown) and a rotor winding (not shown). The stator winding and the rotor winding are common structures used in the art, and thus will not be described herein. In order to adjust a rotational speed of the BLDC motor 1, the value of the stator winding current needs to be controlled. Further, the stator winding current is controlled through modulating an inputted voltage value of the BLDC motor 1. That is, a conduction time of a chopped wave of the BLDC motor 1 is modulated by changing a wave of the voltage to adjust a duty cycle of a pulse width modulation (PWM). In the present invention, a rotational speed of the BLDC motor 1 is able to be controlled. Referring to FIG. 7, in this embodiment, the BLDC motor 1 comprises a Microchip dspic30F6010A being a core of a microcontroller chip, and a plurality of transistors Q1, Q2, and Q3 and Hall sensors H1, H2, and H3. After each of the Hall sensors H1 to H3 detected a rotor position, a counter electromotive force of the BLDC motor 1 and each of the Hall sensors H1 to H3 drive the BLDC motor 1 to rotate according to a commutation signal of the Hall sensors H1 to H3.

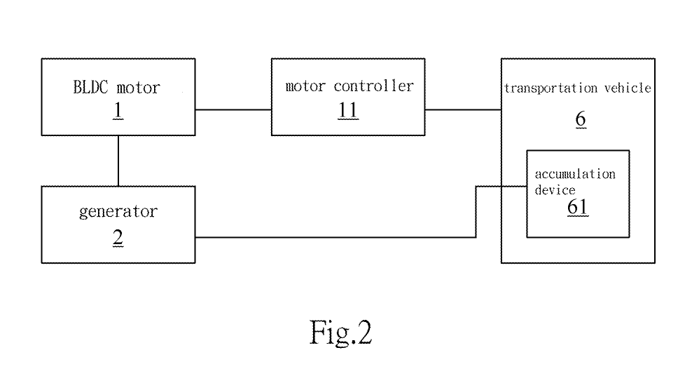

The controls of the chopped wave of the BLDC motor 1 with the three-phase PWM winding usually comprise three strategies: a conventional chopping control, an upper-bridge chopping control, and a hybrid chopping control (PWM-ON, ON-PWM, PWM-ON-PWM). Further, the waveform diagram of the conventional chopping control is shown in FIG. 2. The waveform diagram of the upper-bridge chopping control is shown in FIG. 3. The waveform diagram of the hybrid chopping control is shown in FIG. 4.

Again referring to FIG. 1, the generator 2 is connected to the BLDC motor 1. When the BLDC motor 1 rotates, a coil (not shown) of the generator 2 is synchronously driven to rotate between two poles of a magnet (not shown). Thus, a magnetic field in the coil of the generator 2 is changed, and a sensing current is generated through the change in the magnetic field to generate power.

Again referring to FIG. 1, the magnetic generator 3 is also connected to the BLDC motor 1. Similarly, when the BLDC motor 1 rotates, a metal coil (not shown) of the magnetic generator 3 is synchronously driven to rotate around the two poles of a magnet (not shown) for interrupting a current generated in an electromagnetic field in the metal coil. In one embodiment, the magnet comprises cams (not shown) on the two poles thereof and the magnetic generator 3 comprises a circuit breaker (not shown) including at least one contact point (not shown). When the magnet rotates, the least one contact point of the circuit breaker would be intermittently contacted with the cams to interrupt the current of the magnetic generator 3. However, the above-mentioned structure of the magnetic generator 3 is taken as an example and is not be construed as a limitation. When the electromagnetic field disappears, a voltage is generated on the metal coil of the magnetic generator 3. The contact points of the circuit breaker are in an opened state, and a distance between the contact points means that the voltage on the metal coil of the magnetic generator 3 needs to cross over two ends of the contact points. At the same time, capacitors are placed on the contact points to stabilize electric arcs and the voltage on the metal coil of the magnetic generator 3, and an electric energy dissipation rate on the metal coil of the magnetic generator 3 is controlled to generate power.

Again referring to FIG. 1, the accumulation battery 4 is respectively electrically connected to the generator 2 and the magnetic generator 3, so as to provide the electric energy to the generator 2 and the magnetic generator 3. Further, the accumulation battery 4 is also electrically connected to the motor controller 11 of the BLDC motor 1, and provides electric energy for operating the BLDC motor 1.

Thus, in the operation and utilization of the present invention, the electric energy stored in the accumulation battery 4 is provided to operate the BLDC motor 1 through the motor controller 11. The motor controller 11 adjusts the duty cycle through PWM to further adjust the rotational speed of the BLDC motor 1. While the BLDC motor 1 rotates, the generator 2 and the magnetic generator 3 are synchronously driven to generate power. Further, the electric energy generated by the generator 2 and the magnetic generator 3 are respectively transmitted to the accumulation battery 4 and stored therein, such that the accumulation battery 4 provides the electric energy stored therein for operating the BLDC motor 1 and use of a household appliance. The accumulation battery 4 with stored electric energy is able to be sold to a power company, and the accumulation battery 4 serves as an electric energy source for driving a transportation vehicle.

The present invention further provides a charging system of a brushless motor continuous generator according to another embodiment of the present invention, as shown in FIG. 2. The BLDC motor 1 disclosed by the present invention can be directly applied to a transportation vehicle 6, e.g., an automobile or a motorcycle. Similarly, the generator 2 is respectively connected to the BLDC motor 1 and an accumulation device 61 of the transportation vehicle 6. When the BLDC motor 1 rotates, a coil (not shown) of the generator 2 is driven to rotate between two poles of a magnet (not shown). Thus, a magnetic field in the coil of the generator 2 is changed, and a sensing current is generated through the change in the magnetic field to generate power for providing the accumulation device 61 of the transportation vehicle 6 with electric energy required. Then, the electric energy in the accumulation device 61 of the transportation vehicle 6 is provided to operate the BLDC motor 1 through the motor controller 11 in order to drive the transportation vehicle 6 to progress. In addition, during a rotation process of the transportation vehicle 6, the electric energy is generated thereby and transmits the electric energy back to the accumulation device 61 to store therein.

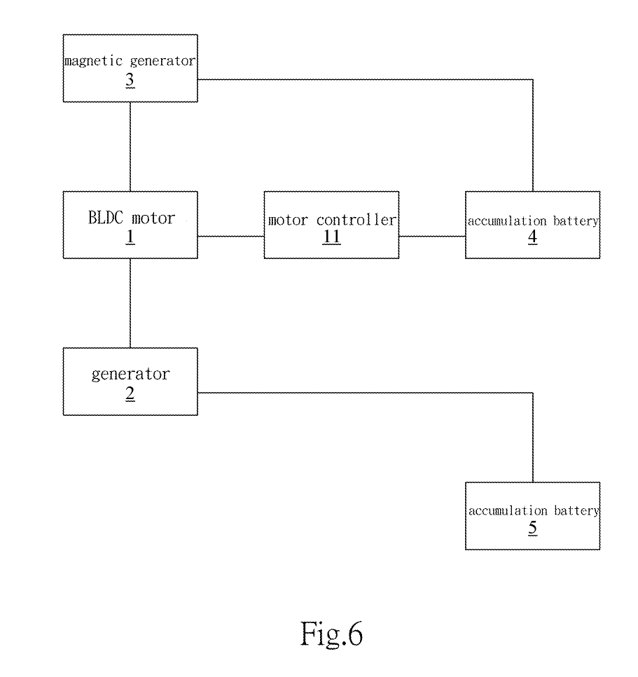

Referring to FIG. 6 shows a block diagram of a charging system of a brushless motor continuous generator according to another embodiment of the present invention. In the charging system of brushless motor continuous generator according to another embodiment of the present invention, the generator 2 and the magnetic generator 3 are respectively connected to two accumulation batteries 4 and 5, between which one of the accumulation batteries 4 and 5 is electrically connected to the magnetic generator 3 and the motor controller 11 of the BLDC motor 1. Thus, electric energy for operating the BLDC motor 1 is provided by one of the accumulation batteries 4 and 5 through the motor controller 11. Another one of the accumulation batteries 4 and 5 being a deep cycle lead-acid battery is electrically connected to the generator 2. Accordingly, another one of the accumulation batteries 4 and 5 is served as the deep cycle lead-acid battery to convert a stored DC electric energy to alternating-current (AC) electric energy through a power converter connected thereto, thereby providing the AC electric energy for use of various household appliances.

In conclusion of the above description, it is known from the description of the constitution and implementation embodiments of the present invention that, comparing the present invention with an existing structure, the present invention is able to be continuously and stably generated power to achieve not only stable and uninterrupted power supply but also utilization convenience, providing enhanced practicability in overall implementation thereof

What is claimed is:

1. A charging system of a brushless motor continuous generator, the charging system comprising:
a brushless direct-current (BLDC) motor, connected to a motor controller, the motor controller adjusting a duty cycle through pulse width modulation (PWM) to change a rotational speed of the BLDC motor; and
a generator, connected to the BLDC motor, the generator synchronously driven to generate power when the BLDC motor rotates.

2. The charging system of a brushless motor continuous generator of claim 1, wherein the BLDC motor is connected to a transportation vehicle comprising an accumulation device.

3. A charging system of a brushless motor continuous generator, the charging system, comprising:
a brushless direct-current (BLDC) motor, connected to a motor controller, the motor controller adjusting a duty cycle through pulse width modulation (PWM) to change a rotational speed of the BLDC motor;
a generator, connected to the BLDC motor, the generator synchronously driven to generate power when the BLDC motor rotates; and
an accumulation battery, electrically connected to the generator for storing electric energy generated by the generator, the accumulation battery electrically connected to the motor controller of the BLDC motor and providing the electric energy for operating the BLDC motor through the motor controller.

4. The charging system of a brushless motor continuous generator of claim 3, wherein the BLDC motor is further connected to a magnetic generator, the magnetic generator is further electrically connected to the accumulation battery, the magnetic generator is synchronously driven to generate power when the BLDC motor rotates and generates the electric energy, and the electric energy is transmitted to the accumulation battery and stored therein.

5. The charging system of a brushless motor continuous generator of claim 3, wherein the electric energy stored in the accumulation battery is provided to a household appliance or is for driving a transportation vehicle.

6. The charging system of a brushless motor continuous generator of claim 3, wherein the accumulation battery storing the electric energy is able to be sold to a power company.

7. A charging system of a brushless motor continuous generator, the charging system, comprising:
a brushless direct-current (BLDC) motor, connected to a motor controller, the motor controller adjusting a duty cycle through pulse width modulation (PWM) to change a rotational speed of the BLDC motor;
a generator, connected to the BLDC motor, the generator synchronously driven to generate power when the BLDC motor rotates;
a magnetic generator, connected to the BLDC motor, the magnetic generator synchronously driven to generate power when the BLDC motor rotates; and
two accumulation batteries, respectively electrically connected to the generator and the magnetic generator, the accumulation batteries respectively storing electric energy generated by the generator and the magnetic generator,
wherein one of the accumulation batteries electrically connected to the magnetic generator is electrically connected to the motor controller of the BLDC motor to provide electric energy for operating the BLDC motor through the motor controller, and another one of the accumulation batteries electrically connected to the generator provides the electric energy for use of a household appliance.

8. The charging system of a brushless motor continuous generator of claim 7, wherein one of the accumulation batteries is a deep cycle lead-acid accumulation battery.

9. The charging system of a brushless motor continuous generator of claim 7, wherein the electric energy stored in the accumulation batteries are provided to the household appliance or is for driving a transportation vehicle.

10. The charging system of a brushless motor continuous generator of claim 7, wherein the accumulation batteries storing the electric energy is able to be sold to a power company.
